(19) United States
(12) Patent Application Publication
(10) Pub. No.: US 2005/0109531 A1
(43) Pub. Date: May 26, 2005

(54) Polymer post insulator apparatus

(75) Inventor: Shuji Fujii, Komaki-city (JP)

Correspondence Address: PARKHURST & WENDEL, L.L.P., 1421 PRINCE STREET, SUITE 210, ALEXANDRIA, VA, 22314-2805, US

(73) Assignee: NGK Insulators, Ltd., Nagoya-city (JP)

(21) Appl. No.: 10/719,017

(22) Filed: Nov. 24, 2003

(51) Int. Cl. H01B 17/00

(52) U.S. Cl. 174/137 R

(57) ABSTRACT

A polymer insulator apparatus having a rectangular structure including plural polymer post insulators, a supporting structure and a plate member, wherein a first end of each polymer post insulator is connected to the supporting structure, and a second end of each said plural post insulator is connected to the plate member. When an axial direction along a length of each plural polymer post insulator is substantially a horizontal direction and an axial direction along a length of the supporting structure is substantially a vertical direction, the plural polymer post insulators support a weight of a load acting in the vertical direction.

### REFERENCE TO RELATED APPLICATION

This application claims priority from Japanese Application 2002-340939 filed Nov. 25, 2002, the entireties of which is incorporated herein by reference.

### BACKGROUND OF THE INVENTION

1. Field of the Invention

The present invention relates to a construction of a polymer insulator apparatus that is mounted in the horizontal direction onto a supporting structure for electric power transmission line path, such as a steel pole, a wood pole, or a steel tower, as well as to a method of mounting the same.

2. Description of the Background Art

A method of applying insulators in which a post insulator is mounted in the horizontal direction onto a supporting structure and a conductor is supported at one end thereof via a suitable connection metal fitting piece, i.e. a so-called line post, is widely applied as a method of compactifying an electric power transmission line path. In recent years, there is an increasing number of examples in which polymer post insulators having a reduced weight and an excellent impact resistance are applied in place of porcelain post insulators. Generally, the polymer post insulators are constructed with a solid FRP core for supporting mechanical load such as flexure (bending) and compression, an outer cover having a weather resistance such as a silicone rubber for protecting the FRP core and imparting a suitable leakage distance to the insulator, and metal fitting pieces for connecting the insulator to a supporting structure and to a conductor or the like.

The line post application in which post Insulators are mounted directly onto a supporting structure can compactify an electric power transmission line path to a greater extent than a suspension and tension insulator application in which insulators are mounted indirectly onto a supporting structure via a crossarm. Application of the line post can reduce the height of the supporting structure and can reduce the occupying width of the electric power transmission line path, so that the site that must be bought will be small and the cost of the electric power transmission line as a whole can be reduced. On the other hand, in the line post, the supported load acts as a cantilever load on the post insulator, so that the permissible supported load of the line post decreases in proportion to the length of the applied post insulator. This restricts the load that can be supported in a high-voltage transmission line that requires a long insulating distance.

In the line post, the permissible supported load can be increased by enlarging the FRP core diameter of the applied polymer post insulator. In addition, as a method for increasing the supported load by structure of apparatus, a braced post structure is known in which one end of the polymer post insulator is connected with a tension type insulator so as to form a triangle with one side being the supporting structure and to form a quadrangle including a crossarm extending horizontally from the supporting structure. Furthermore, as an applied example of the braced post structure, a swivel horizontal vee structure is known in which the mounting part for mounting the polymer post insulator onto the supporting structure has a swiveling structure (See, for example, U.S. Pat. No. 3,002,043, page 1, FIG. 1).

On the other hand, an insulating arm is known as a method for mounting insulators directly onto a steel tower which is one of the supporting structures, although this is not a line post (See, for example, U.S. Pat. No. 3,291,899, page 3, FIGS. 1 and 2). In the insulating arm, an insulating arm for a steel tower is known in which a polymer post insulator is applied as an arm member, and a reinforcing member is inserted into the middle of the arm so that each polymer post insulator is less liable to be deformed. This insulating arm for a steel tower can withstand any load, such as wind pressure, that acts on the electric power transmission line without increasing the FRP core diameter of the polymer post insulator (See, for example, Japanese Utility Model Publication 05-79817/1993, page 1, FIG. 1).

In the above-described line post, the permissible supported load decreases in proportion to the length of the applied polymer post insulator. Further, the polymer post insulator undergoes a larger deflection deformation than the porcelain post insulator, due to its flexibility. This may restrict the range of application as a line post because it may give fears to inhabitants around the electric power transmission line path even though no problem is raised concerning its strength. The amount of deformation relative to the flexure load of the polymer post insulator increases in proportion to the cube of the insulator length, so that a longer insulator length gives a larger deformation. For these reasons, application of the line post constituted with polymer post insulators alone is not so much developed for high-voltage electric power transmission lines exceeding 161 kV that require an especially longer insulator length.

On the other hand, both of the braced post structure and the swivel horizontal vee structure, which are reinforced structures of the aforementioned line post, have a triangle or quadrangle structure with one side being the supporting structure, so that for the mounting thereof the supporting structure and the crossarm must have a length that can constitute one side of a triangle or a quadrangle. Further, both of the reinforced structures are a one-directional reinforced structure regarding the load in the vertical direction, so that they do not provide reinforcement against the load generated in the longitudinal direction due to conductor breaking, uneven wind to the line, snow falls, and the like, or the load temporarily generated in the longitudinal direction at a time of construction of a transmission line. In particular, the swivel horizontal vee structure has a swiveling function for absorbing an excessive impact load generated in the longitudinal direction in an emergency case such as conductor breaking, so as to prevent destruction of the insulator apparatus. This raises a problem in that, unless suitable consideration is given to the transmission line path and apparatus design, the apparatus will whirl and swivel like dominoes by a load in the longitudinal direction that may possibly be generated in a normal state.

The aforementioned insulating arm has a triangular or quadrangular pyramid structure with one face being the mounting part for mounting to the supporting structure, so that the strength thereof can be enhanced in all directions, and no problems such as swiveling are raised. However, this requires a large placement surface, so that the apparatus can be applied only to a supporting structure such as a steel tower having sufficient width and height, and cannot be mounted onto a supporting structure constructed by one pole such as a steel pole or wood pole.

Furthermore, in the case of the structure shown in U.S. Pat. No. 3,291,899, the strength can be enhanced by providing a middle connection metal fitting piece part in the midway of the insulating part, without increasing the FRP core diameter of the applied polymer post insulator. However, as compared with a insulator apparatus without having a middle connection metal fitting piece part, the apparatus increases the costs due to increase in the number of components, in the difficulty of assembling, and in the number of production processes. Also, the apparatus increases the total length of the apparatus for ensuring an insulation distance that is needed because the apparatus construction includes a non-insulator part. This raises a problem of increase in the electric power transmission line path width as well.

An object of the present invention is to enhance the strength against the load in the vertical direction and to reduce the amount of deformation in a line post in which a polymer insulator is mounted in the horizontal direction onto a supporting structure. Further, the present invention aims at providing a polymer insulator apparatus and a method of mounting the same that give a strength larger than the braced post structure against the load in the longitudinal direction, i.e. against the load in the horizontal direction which is perpendicular to the line post, and do not require a large mounting space such as in an insulating arm for a steel tower and hence can be applied to a supporting structure constructed by one pole.

### SUMMARY OF THE INVENTION

A polymer insulator apparatus according to the present invention is characterized in that a plurality of polymer post insulators are arranged in parallel and two ends thereof are connected, whereby the strength of the polymer insulator apparatus is increased in the direction of arrangement of the polymer post insulators.

A method of mounting plural polymer post insulators according to the present invention is characterized in that, in mounting the above-described polymer insulator apparatus in the horizontal direction onto a supporting structure, the polymer insulator apparatus is mounted by arranging the-polymer post insulators in parallel in the vertical direction and connecting two ends thereof.

According to the above-described construction, the strength in the vertical direction in particular can be improved in the present invention. Of course, it goes without saying that, by arranging the polymer post insulators in parallel in an arbitrary direction other than the vertical direction and connecting two ends thereof, the strength in an arbitrary direction can be greatly improved. Also, the strength in a direction other than the direction of parallel arrangement can be improved as compared with the strength of a single polymer post insulator, though the improvement is not so great as in the direction of parallel arrangement.

Further, since the polymer insulator apparatus of the present invention is constructed by arranging a plurality of polymer post insulators in parallel, the area to be mounted onto is smaller as compared with that in other reinforcement structures mentioned above as the prior art, so that the apparatus of the present invention can be applied to any supporting structure such as a steel tower or a prism or cylinder constructed by one pole.

Further, since it is clear that the weight of the electric power transmission line acts in the vertical direction, it is preferable that, in mounting the polymer insulator apparatus in the horizontal direction onto the supporting structure, the plurality of polymer post insulators are arranged in parallel in the vertical direction, and the two ends thereof are connected. By doing so, the polymer insulator apparatus of the present invention can exhibit the maximum performance.

### BRIEF DESCRIPTION OF THE DRAWINGS

FIG. 1 is a side view showing one construction example of a polymer post insulator constituting a polymer insulator apparatus according to the present invention;

FIG. 2 is a side view showing one construction example of a polymer insulator apparatus according to the present invention; and

FIG. 3 is a front view showing the polymer insulator apparatus of the present invention shown in FIG. 2.

### DESCRIPTION OF THE PREFERRED EMBODIMENTS

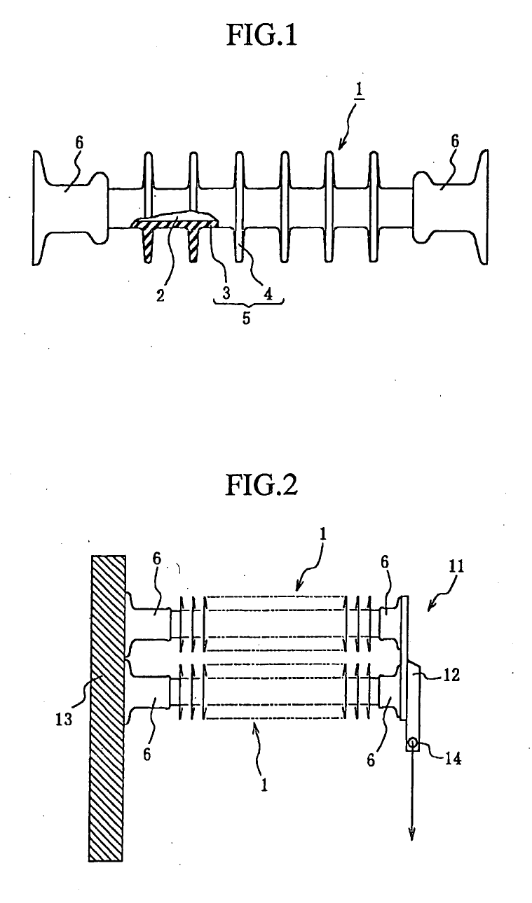

FIG. 1 is a view showing one construction example of a polymer post insulator constituting a polymer insulator apparatus according to the present invention. In the example shown in FIG. 1, a polymer post insulator 1 is constituted with a core member 2, an outer cover 5 made of a sheath 3 and sheds 4 disposed around core member 2, and holding fitting metal pieces 6 disposed at two ends of core member 2. Further, core member 2 is made of, for example, a solid FRP, and outer cover 5 made of sheath 3 and sheds 4 is made of, for example, silicone rubber. Also, an end of holding metal fitting piece 6 has a flange shape, and is constituted to be capable of being fixed onto a planar plate member or the like with screws. The construction of this polymer post insulator is the same as in the prior art.

FIG. 2 is a view showing one example of a polymer insulator apparatus according to the present invention. In the example shown in FIG. 2, a polymer insulator apparatus 11 according to the present invention is constructed by connecting a plurality (here, two) of polymer post insulators 1 in parallel with the use of a plate member 12. Namely, at one end of two polymer post insulators 1, each holding member 6 is fixed onto a supporting structure 13 made of a steel pole or a wood pole individually with screws and, at the other end of two polymer post insulators 1, each holding member 6 is fixed onto a plate member 12 individually with screws.

With this construction, polymer insulator apparatus 11, which is integrated as a rectangular structure having two polymer post insulators 1, supporting structure 13, and plate member 12 as constituent elements, is mounted onto supporting structure 13. In this example, the apparatus functions as a line post by supporting a conductor (not illustrated) through the intermediary of a conductor mounting part 14 disposed at one end of plate member 12.

In the example shown in FIG. 2, two polymer post insulators 1 are vertically arranged in parallel and mounted horizontally onto supporting structure 13. In this case, the conductor load applied to conductor mounting part 14 is applied in the direction shown by the arrow in FIG. 2, and acts as a cantilever load on the polymer insulator apparatus having a rectangular structure shape. The cantilever load is applied in a decomposed form, namely, as a tensile load onto the upper polymer post insulator constituting the rectangular structure and as a compressive load onto the lower polymer post insulator constituting the rectangular structure. Since the FRP core giving the mechanical strength of the insulator can withstand tension and compression to a greater extent than flexure, the apparatus can exhibit a strength more than the multiple of the number (here, two) of the applied polymer posts because the load applied to the polymer post insulator is converted from flexure to tension and compression by means of the rectangular structure structure. The strength is a function of the length of the polymer post insulator and the diameter of the applied core, and changes in various ways by combination of the two.

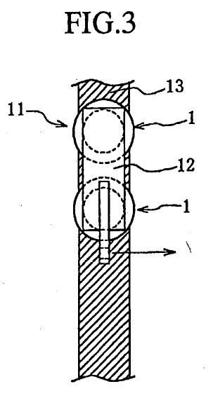

In addition, in the example shown in FIG. 3, against the horizontal load in the longitudinal direction shown by the arrow, the apparatus can exhibit a strength that the multiple of the number (here, two) of the insulators arranged in parallel. In this way, with the use of the polymer insulator apparatus 11 according to the present invention in which a plurality of polymer post insulators 1 are arranged and connected in parallel, the strength in an arbitrary direction can be increased and the deflection can be restrained without increasing the diameter of the FRP core of the polymer post insulator.

Here, in the above-described examples, the polymer insulator apparatus 11 is constructed by arranging and connecting two polymer post insulators 1 in parallel; however, it goes without saying that the number of polymer post insulators 1 constituting the polymer insulator apparatus 11 is not limited only to two. When a plurality (more than two) of polymer post insulators 1 are arranged and connected in parallel in one direction, the strength in the direction of parallel arrangement can be further increased to construct a polymer insulator apparatus 11 according to the present invention. However, when the number of polymer post insulators is increased, a larger space will be needed to mount the polymer insulator apparatus along the direction of parallel arrangement. Therefore, the number of polymer post insulators 1 must be determined in accordance with the diameter of the FRP core of the polymer post insulators 1 to be used, the strength that is required, the place on which the apparatus is to be mounted, and so on.

Furthermore, in the above-described examples, an end of holding fitting metal piece 6 has a flange shape and is fixed onto plate member 12 with screws; however, it goes without saying that holding metal fitting piece 6 can be fixed onto plate member 12 with any means as long as it can be fixed. Similarly, the end of the holding metal fitting piece 6 opposite to the end fixed to plate member 12 also has a flange shape and is fixed onto supporting structure 13 such as a steel pole with screws; however, it goes without saying that holding fitting metal piece 6 can be fixed onto supporting structure 13 with any means as long as it can be fixed. However, since the strength is increased by a combination structure of a rigid rectangular structure in the present invention, the connection between holding metal fitting piece 6 and plate member 12 and the connection between holding metal fitting piece 6 and supporting structure 13 described above must be implemented by fixation and not by means of hinges as used occasionally in the prior art, since hinges are not effective.

As will be clearly understood from the above description, since a plurality of polymer post insulators are arranged in parallel and the two ends thereof are connected in the present invention, in mounting a polymer insulator apparatus in the horizontal direction onto a supporting structure, the polymer insulator apparatus can be mounted so that the direction of parallel arrangement and connection of the polymer post insulators will be the vertical direction. Therefore, in particular, the strength in the direction of the weight of the electric power transmission line, i.e. in the vertical direction, which is the most important direction in the polymer insulator application, can be improved.

1-3. (canceled)

4. A polymer insulator apparatus comprising a rigidly connected rectangular structure comprising plural polymer post insulators, a supporting structure and a plate member, wherein a first end of each polymer post insulator is rigidly connected to said supporting structure, and a second end of each said polymer post insulators is rigidly connected to said plate member.

5. A method for mounting plural polymer post insulators on a supporting structure, comprising:
providing a supporting structure and plural polymer post insulators;
rigidly connecting a first end of each said plural polymer post insulator to the supporting structure; and
rigidly connecting a second end of each said plural polymer post insulator whereby said plural polymer post insulators are parallel to each other and normal to the supporting structure, thereby forming a rigidly connected rectangular structure.

6. The method according to claim 5, wherein said first end of each said polymer post insulator is connected to said supporting structure by a first rigid body comprising a part of said polymer post insulator, and said second end of each said polymer post insulator is connected to a plate member by a second rigid body comprising a part of said polymer post insulator.

7. The method according to claim 5, wherein said connecting of the first end and said connecting of the second end each comprise a rigid connection.

8. The method according to claim 5, wherein when an axial direction along a length of each said plural polymer post insulator is substantially a horizontal direction and an axial direction along a length of said supporting structure is substantially a vertical direction, then said plural polymer post insulators are for supporting a weight of a load acting in the vertical direction.

9. The polymer insulator apparatus according to claim 4, wherein said supporting structure is configured for operating with an electric power transmission line.

10. The method according to claim 5, wherein said supporting structure is configured for operating with an electric power transmission line.

11. A polymer insulator apparatus comprising a rigidly connected rectangular structure comprising plural polymer post insulators, a supporting structure and a plate member, wherein a first end of each polymer post insulator is rigidly connected to said supporting structure, and a second end of each said polymer post insulators is rigidly connected to said plate member, wherein said supporting structure is selected from the group consisting of a steel pole, a wood pole or a steel tower.

12. A method for mounting plural polymer post insulators on a supporting structure, comprising:
providing a supporting structure and plural polymer post insulators;
rigidly connecting a first end of each said plural polymer post insulator to the supporting structure; and
rigidly connecting a second end of each said plural polymer post insulator whereby said plural polymer post insulators are parallel to each other and normal to the supporting structure, thereby forming a rigidly connected rectangular structure, wherein
said supporting structure is selected from the group consisting of a steel pole, a wood pole or a steel tower.
